(19) United States
(12) Patent Application Publication
(10) Pub. No.: US 2021/0019802 A1
(43) Pub. Date: Jan. 21, 2021

(54) Presenting Search And Comparison Results

(71) Applicant: Chian Chiu Li, Fremont, CA (US)

(72) Inventor: Chian Chiu Li, Fremont, CA (US)

(21) Appl. No.: 17/062,641

(22) Filed: Oct. 5, 2020

Related U.S. Application Data
(63) Continuation-in-part of application No. 15/430,465, filed on Feb. 11, 2017, now abandoned.

(51) Int. Cl. G06Q 30/06; G06F 16/9532; G06F 16/9035

(52) U.S. Cl. CPC G06Q 30/0629; G06F 16/9035; G06F 16/9532

(57) ABSTRACT

Systems and methods for presenting search results or comparison results after receiving a query from a user. A search window presents a search button as a search option and a comparison button as a comparison option. The search results are based on the query. The comparison results are based on an object derived from the query and comparators that are comparable to the object. A database includes comparison attributes that contain the comparison results.

### CROSS REFERENCE TO RELATED APPLICATION

This is a continuation-in-part of U.S. patent application Ser. No. 15/430,465, filed Feb. 11, 2017.

### BACKGROUND

### Field of Invention

This invention relates to presenting online search results, more particularly to presenting search results and comparison results after receiving a query.

### Description of Prior Art

The Internet has become a colossal reservoir of data where we try to store almost everything which is digital. The reservoir may contain a vast amount of information covering all kinds of subjects, objects, and areas, like knowledge, data collected, records of personal and collective experiences, records of events and activities, or in some occasions, any digital info we could have. When a user wants to learn something, the user may log on a searching website to get lots of web page links, which may provide ample information on an object, such as what it is, its contact or access info, reviews, comments, and other related info posted on the Internet. A conventional search result, however, doesn't provide comparison results among competitors or similar objects directly. A conventional search may present direct introduction to an object, but not how it compares with other objects. When a user wants to see a comparison result, the user has to find online reviews first. But many objects don't have reviews. Even when reviews are available, a user has to spend time reading through them, which may not be practical in cases when immediate answer is needed such as in front of a restaurant or in a shopping mall. Thus, it's inconvenient to get comparison results using a conventional search method.

In our daily life, comparison results are important and desirable many a time. For instance, when a user is about to purchase a product, the user may want to compare it with other similar products in terms of price, reviews, and specifications. Currently, an online search is conducted around an object, not relations between an object and other objects. A user may have to do a search, rake out useful webpage links from pages of search results, get review articles, and then compare an object with another one. Thus, getting comparison results through a conventional search requires several steps and is not convenient. There exists a need for an improved search process which provides comparison results.

A database is an organized collection of data sets. It provides for storage and retrieval of data or information electronically and efficiently. There are different database types utilizing different structures to organize data sets. Take one common database structure for instance. It may contain a database table having rows and columns. Each data set may be a row, which may also be called a record or entity. An entity may contain corresponding column units of the database table, which may be called fields or attributes. For applications in conventional search and some other occasions, a regular database may consist of entities. Each entity may represent an object and contain attributes. The attributes may contain info of the object.

Usually a database features a large amount of entities. For a database used for conventional search, its entities or the entity's attributes only contain info on objects, like an object's meaning, property, and links to web pages where related info are arranged. But the entities or attributes don't include data which may be used to present comparison results among certain objects. For instance, if an object is “Pizza Time”, the attributes may involve a brief introduction of the eatery, its menu, open hours, street address, phone number, and website address. The attributes normally don't contain comparison data which is ready for retrieval for “Pizza Time” and nearby competing pizza places. To compare it with others, a user may have to do some searches, obtain relevant information, and get comparison results manually. The above comparison process requires certain knowledge, patience, and skills and thus is not a solution for all users. Therefore, there exists a need to provide an improved database which contains comparison data for direct retrieval.

### TARGETS AND ADVANTAGES

Accordingly, several main targets and advantages of the present invention are:
a). to provide an improved system and method to present online search results and comparison results;
b). to provide such a system and method which provide a search option and a comparison option simultaneously;
c). to provide such a system and method which present comparison results using concise summaries;
d). to provide such a system and method which produce a database having comparison attributes; and
e). to provide such a system and method which create comparison attributes for direct retrieval of comparison data.

Further goals and advantages will become apparent from a consideration of the drawings and ensuing description.

### SUMMARY

In accordance with the present invention, a search option and a comparison option are presented in a search window simultaneously. The search option provides conventional search results. The comparison option provides comparison results among an object and other objects. Comparison results are presented using concise summaries which feature the same format, similar or same wording, and/or a few items only. To accommodate needs of presenting comparison results, comparison attributes are created and added to a database. Comparison attributes enable quick retrieval of comparison information.

### DRAWING FIGURES

FIG. 1 is a block diagram showing a prior-art network environment.

FIG. 2 is a block diagram showing a prior-art server 16 of FIG. 1.

FIG. 3 is a schematic block diagram of a log processing system of a server in accordance with the present invention.

FIG. 4 is a schematic block diagram of a searching system of a server in accordance with the present invention.

FIG. 5 is a schematic flow diagram showing a process to collect info, obtain comparison data, and create attributes and an entity in accordance with the present invention.

FIG. 6 is a schematic flow diagram showing processes to retrieve and send search results and comparison results respectively in accordance with the present invention.

FIG. 7 is a schematic block diagram of a client system in accordance with the present invention.

FIGS. 8-A and 8-B are exemplary diagrams showing search and comparison options in a search interface in accordance with the present invention.

FIGS. 8-C to 8-F are exemplary diagrams showing comparison results in a search interface in accordance with the present invention.

FIG. 9 is a schematic flow diagram describing search and comparison processes respectively in accordance with the present invention.

FIGS. 10-A, 10-B, and 10-C are exemplary diagrams showing search and comparison options in a search interface in accordance with the present invention.

### REFERENCE NUMERALS IN DRAWINGS

| | |
|---|---|
| 10 Client | 12 Communication Network |
| 14 Input Module | 16 Server |
| 18 Output Module | 20 Presentation Module |
| 22 Memory & Storage | 24 Processing Module |
| 26 Communication Interface | 28 Bus |
| 30 Front End | 32 Processing Unit |
| 34 Site Storage | 36 Log Data Storage |
| 38 Search Module | 40 Log Processing System |
| 42 Searching System | 44 Computer Readable Medium |
| 46 Processor | 48 Client |
| 50 Display | 52 Query Input Window |
| 54 Search Button | 56 Comparison Button |
| 58 Comparison Window | 60 Button |
| 62 Button | 64 Display Surface |
| 66 Comparison Window | 68 Display |
| 70 Query Input Window | 72 Display Surface |
| 74 Search Button | 76 Comparison Button |
| 78 Comparison Window | 80 Image Search Button |
| 82 Video Search Button | |
| 100, 102, 104, 106, 108, 110, 112, | |
| 114, 116, 118, 120, 122, 124, 126, | |
| 128, 130, 132, 134, 136, 138, 140, | |
| 142, 144, and 146 are exemplary steps. | |

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

FIG. 1 is an exemplary diagram of a prior-art network system which may be used to implement principles of the current invention. The network system may comprise clients 10 and servers 16 which are connected via a communication network 12. The numbers of clients and servers in FIG. 1 are arbitrary for illustrating the methods and systems. The clients or servers may be the same or different in characteristics and their functionality may change in practical applications.

Clients 10 may cover a range of real or virtual things such as a thread or process running on a device, an object executable by a device, an electronic device or gadget, e.g., a desktop computer, a notebook computer, a tablet computer, a smartphone, a smart watch, a virtual reality (VR) device, an augmented reality (AR) device, and the like.

The word “server” as used herein means a system or systems which may have similar functions and capacities as one or more servers. Main components of a server may include one or more processors, which control and process data and information by executing software, logic, or codes, or carrying out any other suitable functions. A server and/or processor, as a computing device, may include any hardware, firmware, software, or a combination. In the most compact form, thanks to the progress of microelectronics, a server may be built on a single processor chip. In the figure, servers 16 may represent one or more server devices that collect, process, store, maintain, and/or manage information and documents, execute a search process requested by a user and deliver search results to the user.

Network 12 may cover a range of types such as a local area network (LAN), a wide area network (WAN), a telephone network, an intranet, the Internet, wireless, and other types of networks. Clients 10 and servers 16 may be connected to network 12 or among themselves by various wired, wireless, optical, direct or relayed connections.

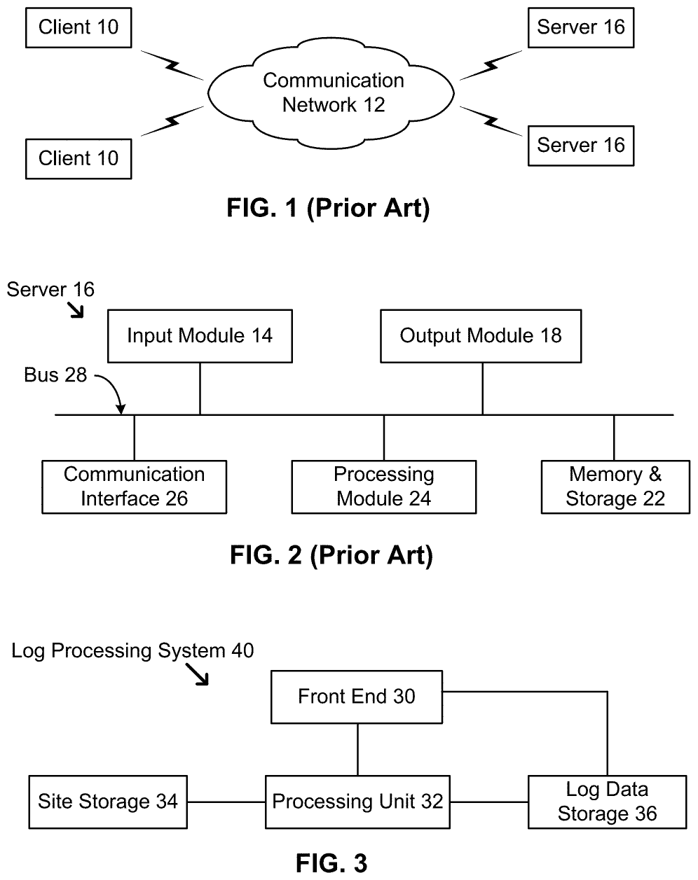

FIG. 2 is a schematic block diagram of prior-art server 16 of FIG. 1. Server 16 may comprise an input module 14, an output module 18, a memory & storage module 22, a processing module 24, a communication interface 26, and a bus 28. Bus 28 provides communication means among the modules and devices.

Input module 14 may comprise a function that permits and enables an operator to feed information to server 16. Keyboard, mouse, voice or gesture recognition devices are examples of module 14. Output module 18 presents or displays output information. Examples of output module are monitor, printer, smart phone, or other information output devices. Memory & storage module 22 may comprises random access memory (RAM), read only memory (ROM), magnetic storage, optical storage, or other memory and storage media. Processing module 24 may comprise various types of processors which receive and execute instructions. Communication interface 26 may comprise any communication mechanism that enables server 16 to exchange information with other devices and systems either locally through bus 28 or remotely through network 12.

Processing module 24 may process information or documents obtained from web pages of various web sites, generate data associated with the web sites, and then store the data using memory & storage 22. Module 24 may also access information stored in memory & storage 22 to acquire needed data. Module 24 may perform these operations in response to executable software instructions kept in a computer-readable medium, such the RAM or ROM part of device 22.

FIG. 3 is a schematic functional block diagram of a log processing system 40 of a server according to the present invention. System 40 may comprise a front end 30, a processing unit 32, site storage 34, and log data storage 36. The blocks each may represent a processor, a thread, and/or an object. The blocks or functions depicted here and in other figures may be implemented in software, hardware, or a combination of hardware and software. Using integration or system-on-chip technologies, system 40 and other systems described here may also be built by fewer blocks or chips, or even a single block or single chip to realize functions pursued, and to reduce the system size and power consumption.

Front end 30 works as the front end of log processing system 40 and receives information or documents related to users and user access of web pages and web sites such as hypertext transfer protocol (HTTP) requests. Web access information of users includes visits on various sites and web pages, which may be sent to and stored in log data storage 36. Log storage 36, as shown in FIG. 3, is directly connected to front end 30. It stores data transferred via front end 30, which may include other user related info which is either submitted by users or collected via other means, such as user names, passwords, URL, geographic locations, online survey records, online search records, etc.

Processing unit 32 may analyze a user by information stored in log data storage 36 and send analysis results to site storage 34. The results may illustrate user activity, history, and habit while surfing on the Internet. Main functions of site storage 34 may include collecting and storing information on almost all objects and subjects from almost all web pages. Information stored in site storage 34 may include texts, images, video, audio, documents, programs, links to web pages and website, etc.

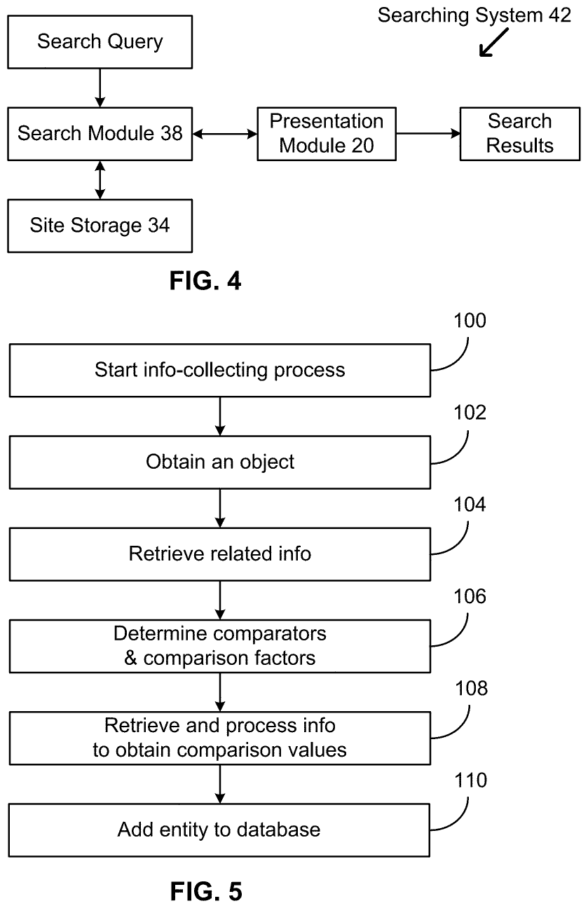

FIG. 4 is a schematic functional block diagram of a searching system 42 of a server according to the present invention. The functions illustrated in FIG. 4 may be realized by software, hardware, or a combination of hardware and software. The blocks each may represent a processor, a thread, and/or an object, and may be integrated into fewer blocks or even one block without changing the functions. A search query may be any text, image, video, audio, or symbol a user submits to searching system 42. After a query is received from a user, system 42 may search the Internet accordingly, and combine the searching results with previous search results stored at site storage 34 to produce consolidated results, which may be presented to the user by text, charts, web site lists or links, etc.

Searching system 42 may comprise a search module 38 and a presentation module 20, while in practice the two modules may be integrated into one device. After search module 38 receives a search query from a user, it may analyze the query, identify a key object, access the Internet and site storage 34 to retrieve relevant documents, and then generate an initial result, which is sent to presentation module 20. Module 20 may further process the initial result, produce a search result, and then send the search result to the user. The search result may be presented in text, table, image, video, or other applicable forms. The functions of presentation module 20 may include data/information categorizing, sorting, filtering, summarizing, chart and curve drawing, and other ways to present a search result. The manner in which a search result is displayed may be determined by a user preference, an analysis on user viewing history, or a predetermined arrangement. As described above, search module 38 may have the capacity to access data and documents on the Internet and at site storage 34. After completing a search, search results and certain related info may be stored at site storage 34 for future use.

Theoretically, after receiving a search query from a user, a search may be performed via the Internet to collect up-to-date info. But searching the Internet takes time, as there are millions of websites. On the other hand, many users may want to get search results as soon as possible. Thus, a practical solution is to search the Internet, prepare search results for given groups of objects in advance, and build databases to store the search results at internal facilities like site storage 34 of FIG. 4. When a query comes in, instead of spending time searching the Internet, system 40 may locate a matching object at the databases and retrieve prearranged search results in a short period of time. As info posted on the Internet may be created, updated, or changed constantly, continued searches for new info and updates on the Internet become necessary. Once new data arrives, databases at site storage 34 may be updated in response.

As illustrated above, conventional databases consist of entities which only contain information that is directly related to an object, like web page links to introductory articles, relevant news, reviews, etc. After a query is received, an object is determined based on the query. Then a corresponding entity is identified and the entity's attributes are found. Info retrieved from the attributes is presented to a user as search results. With such database data, however, it is inconvenient and time-consuming to get comparison results, because obtaining comparison results involves comparing methods and collecting information on comparable objects. In order to get comparison info as fast as getting search results, a direct retrieval step is needed. Direct retrieval requires that a database contains relevant data which is ready for pick-up anytime. Thus, there exists a need for an improved database. The improved database may have comparison attributes. Comparison attributes may be created for an entity to store comparison data. From comparison attributes, comparison data may be retrieved instantly.

In some embodiments, an entity, representing an object, may contain one or more comparison attributes. Comparison attribute may store data for the object and one or more comparators. The word “comparator”, as used herein, may indicate an item or entity which the object is compared to. For example, when a database contains a pizza restaurant “Pizza Time” as an object, other pizza restaurants within a certain distance may be chosen as comparators. That is, a user may compare “Pizza Time” with these restaurants. After comparators are chosen, comparison factors may be selected or determined. Comparison factors may represent aspects to be compared, such as price, review results, certain characteristics, certain specifications, etc. Hence, an object and its comparators may have a specific group of comparison factors, or an object and its comparators may be compared via certain aspects respectively. In some embodiments, a value or status may be determined and assigned to an object or comparator under a comparison factor. The value or status may be referred to as a comparison value. When an object and its comparators each have a comparison value under a comparison factor, they may be compared by the comparison values under the comparison factor. Comparison values provide a short answer and easy-to-understand content and enable a concise comparison report that may be quick and easy to review.

Comparison attributes contain information on objects, comparators, comparison factors, and comparison values. After comparison attributes are arranged for an entity of an object, the object becomes ready for direct retrieval of comparison data. Take modules or devices of FIG. 4 for example. Assume that a database is built at site storage 34, where certain objects have one or more comparison attributes. The comparison attributes contain comparison information among the objects and their comparators. When a query is received from a user asking for comparison results of an object, search module 38 may launch a process to find an entity of the object and its comparison attributes. Then comparators, comparison factors, and comparison values are located at the attributes. Next, presentation module 20 may process the comparison data, generate comparison results, and send the results to the user. Examples of the comparator, comparison factor, comparison value, and comparison result are illustrated below.

FIG. 5 is a schematic flow diagram illustrating processes to collect data, arrange comparison information, and create a new entity in accordance with the present invention. At step 100, a process to collect and prepare information begins. Assume that a database is already constructed and the following steps are used to add an entity to it. The database is different from a traditional database in that it contains extra attributes, comparison attributes. As such, comparison data may be added to an entity according to certain rules and become part of attributes' content. As an entity stands for an object, when a new entity is created for the database, data of an object may be assigned to the new entity's attributes, e.g., comparison data may go to the comparison attributes. It is the comparison attributes that make the database different from a traditional database. Comparison attributes also make it convenient to retrieve comparison data for a searching system. It is noted that a comparison attribute is a complementary but not necessary part of an entity or database. An entity may or may not have valid comparison attributes. If an entity has comparison attributes, it provides ease for getting comparison results. If an entity has no comparison attribute or blank comparison attributes, the entity is still valid and useful.

At step 102, an object is obtained. The object will be added to the database in the form of entity. Further, a search is conducted at step 104 to retrieve information from the Internet and other sources with regard to the object. The search may be a conventional search. Search results may be processed and distributed among matching attributes.

Since a conventional search result doesn't include needed comparison information, steps 106 and 108 are arranged for preparing comparison attributes. It may be arranged such that these two steps are arranged automatically when a new entity is created for the database. It may also be arranged that when an entity of an object is created for the database, the object goes through a qualifying test first. The test may contain questions such as whether the object belongs to certain kinds of product or certain fields of business, whether it is located in certain geographic areas if it is in certain business, whether a certain number of comparison requests has been received for the object, and so on. If an object passes the test, these two steps may be carried out and comparison attributes may be set up for its entity. If it fails the test, these two steps may be skipped and its comparison attributes may be left empty.

At step 106, comparators are determined or chosen based on information of the object. For a comparison scenario, at least one comparator needs to be determined for the object. Comparators represent something comparable, i.e., they bear certain characteristics similar to the object so that they may be compared with each other. As illustrated above, certain nearby pizza places may be chosen as comparators for “Pizza Time”. These pizza places may resemble “Pizza Time” in terms of location and the nature of business which make them comparable to “Pizza Time”. Certain searches and analysis are needed to select comparators. Preferably, comparators may be selected by a given algorithm automatically.

Next, comparison factors are determined. A comparison factor may be what to be compared for. It is meaningless to compare an object and its comparators without supporting data, which is like to compare abstract names. An object and its comparators may be compared via factors such as certain properties, specifications, characteristics, or features. For example, price, battery life, and review rating by users may be the choices of comparison factors for a smartphone. After comparison factors are defined, step 108 is performed. At this step, searches may be arranged to get information that is related to the object, the comparators, and the comparison factors and then the information may be processed to obtain or extract comparison values for the object and each comparator. A comparison value may represent a value, a condition, a degree, or status of an object or comparator under a comparison factor. A comparison value may have various forms such as a numerical number (e.g., a number 15 standing for fifteen hours of battery life), a textual expression (e.g., “Excellent” for review rating), number of stars, or another format of suitable expression. When a comparison event happens, it is the comparison values under a comparison factor that are compared for an object and its comparators.

Information of the object, comparators, comparison factors, and comparison values may be used to created comparison attributes. After comparison attributes are formed, they may be aggregated with other attributes of the entity. At step 110, the entity may be added to the database.

Assume that an object has an entity at a database. The entity may include comparison attributes. The comparison attributes may contain information of the object, comparators, comparison factors, and comparison values. When a request for comparison results of the object is received, a search module may find the entity at the database, and then check whether its comparison attributes are available. If the answer is yes, content of the comparison attributes may be retrieved, and comparison values may be obtained and used for display of comparison results. Since a simple and easy-to-read report is desirable among users, comparison values are expected to be short and clear. In some embodiments, a concise summary of an object or comparator under a comparison factor may be taken as a comparison value. For instance, assume that there is a task to get a comparison value. The object is a restaurant and the comparison factor is of price. Because there are many dishes on the menu, a summarization process is needed to reflect the overall price aspect of the restaurant. One summarization method is of averaging. Prices of selected dishes are averaged to get a medium price. The medium price may be used as a concise summary of prices. It may also be used as a comparison value under the price factor for the restaurant.

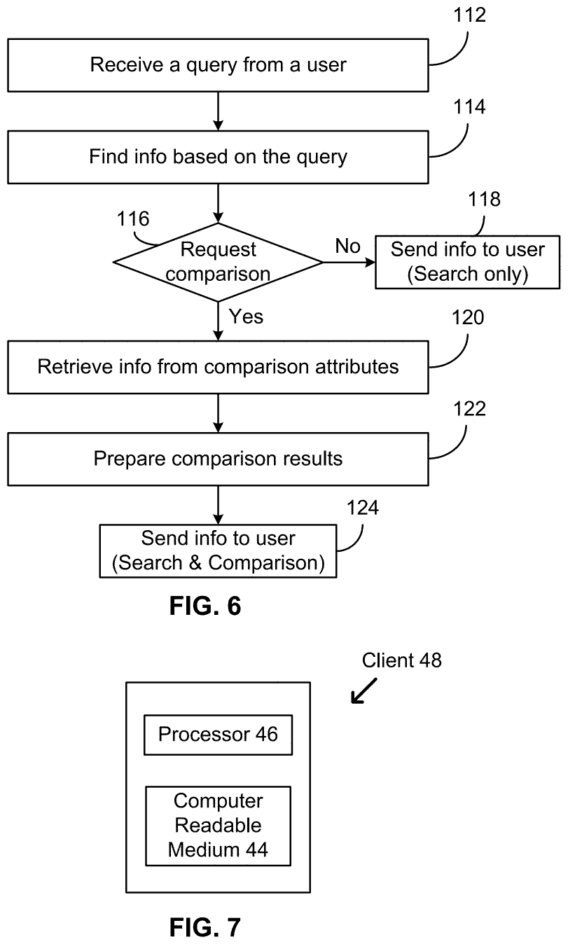

Referring to FIG. 6, assume that a server or searching system receives a query from a user at step 112. The server or searching system may start a search at given databases at step 114. Next, whether the user requests comparison results is checked at step 116. If the user asks for a conventional search, step 118 is taken and conventional search results are retrieved and sent to the user. Conventional search results contain results based on the query or around an object only. The results don't provide comparison info directly. If the user wants comparison results, Step 120 is performed. Content of comparison attributes may be retrieved by certain algorithms automatically. Optionally, not all content of comparison attributes are presented to a user at a time. Instead, data at comparison attributes is processed by the server or searching system at step 122, during which some attribute content may be selected based on the query and certain arrangements. At step 124, selected attribute content as comparison results are sent to the user.

When a user requests comparison information, conventional search results may or may not be sent to the user. As comparison results and conventional search results are complementary and both may be in need even when a user requests the former, it may be arranged that both may be given to the user as a default setting. In some embodiments, options may be arranged and presented to a user. The user may choose to receive the comparison results and skip the conventional search results. Alternatively, the users may also choose to receive both the comparison results and search results and present them on a display together.

FIG. 7 is an exemplary block diagram of a client system 48 according to the present invention. As illustrated above, client 48 may represent an electronic device, including but not limited to a desktop computer, a laptop computer, a tablet computer, a smartphone, a smart watch, a VR or AR device, etc. Client 48 may include a processor 46 and computer readable medium 44. Processor 46 may mean one or more processor chips or systems. Medium 44 may include a memory hierarchy built by one or more memory chips or storage modules like RAM, ROM, FLASH, magnetic, optical and/or thermal storage devices. Processor 46 may run programs or sets of executable instructions stored in medium 44 for performing various functions and tasks, e.g., surfing or searching on the Internet, playing video or music, electronic payment, social networking, sending and receiving emails, short messages, files, and data, executing other applications, etc. Client 48 may also include input, output, and communication components, which may be individual modules or integrated with processor 46. Communication components may connect the device to a server or another device via a communication network. Usually, client 48 may have a display (not shown) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for a user to enter input and interact with a system.

Further, client 48 may have a voice recognition component to receive a user's verbal command or audio input. In addition, client 48 may have a gesture detection mechanism to receive a user's gesture instructions. For VR and AR devices and some wearable devices, a virtual screen or a screen having a very small size may be arranged. A virtual screen may be part of a displaying system which may not have a physical screen structure. While it is impractical or inconvenient to touch a virtual screen or very small screen, verbal commands and gesture instructions may become useful for users. In descriptions below, the word “screen” or “display” may include a device that is virtual or very small. For the latter case, a screen may be smaller than a one-inch-by-one-inch square or even smaller than a fingertip. A search interface or search window may be presented via all kinds of screens or displays including a virtual screen or very small screen.

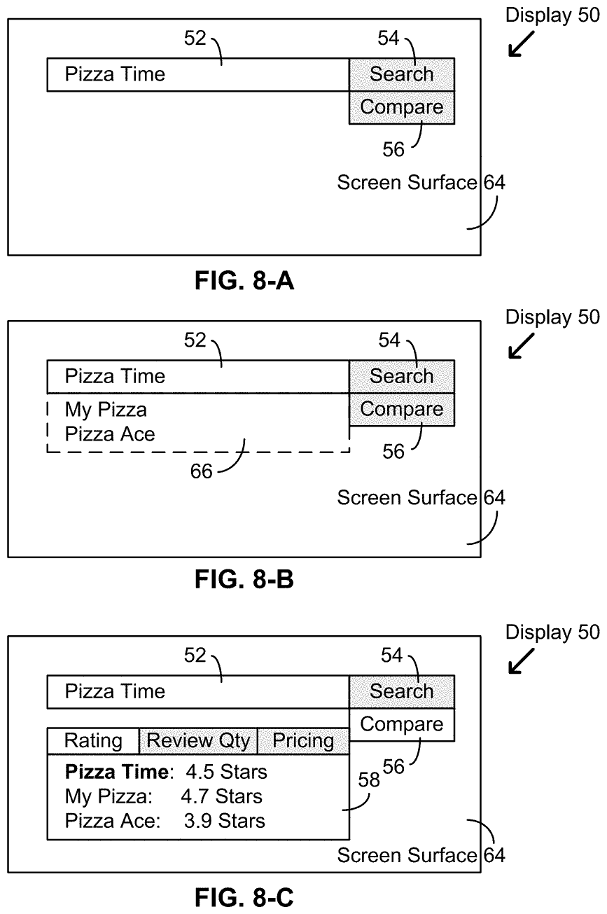

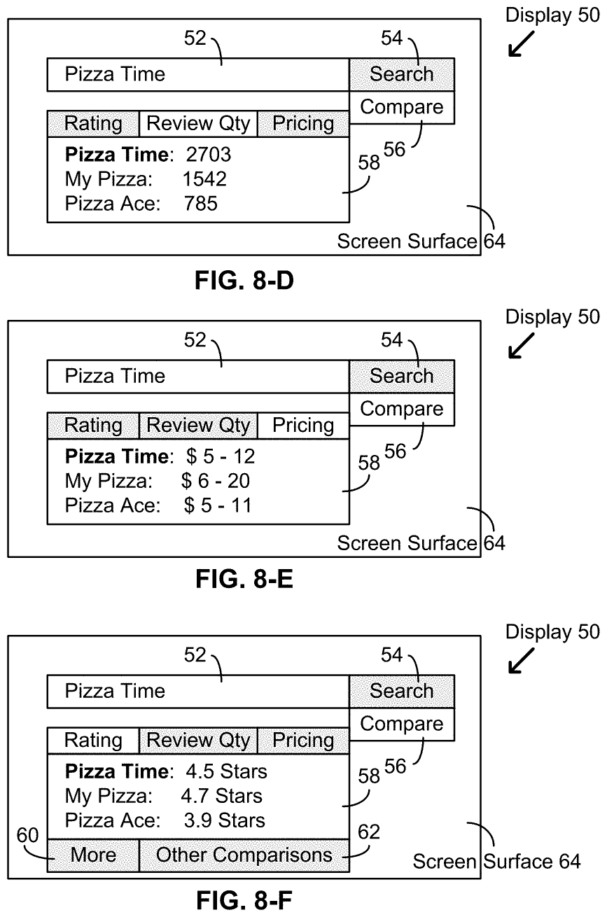

After receiving a comparison request from a user, a server or searching system may provide comparison results for presentation. FIGS. 8-A to 8-F are exemplary diagrams of presenting comparison results according to the present invention. As shown in FIG. 8-A, a search interface or search window is presented on a screen surface 64 of a display 50. Display 50 may a part of an arbitrary client system or electronic device. In some embodiments, the search interface may be a portal page of a search website. The content items on surface 64 may also be a portion of a screen view which mainly serves other programs, where searching functions are provided as a separate and complementary feature. For example, many websites, e.g., online stores and business reviews sites, have a searching area or search window on their web pages. In order to accommodate a search task, a query input window 52 is configured on surface 64. Window 52 represents a space for input in the interface. A user may use window 52 to enter a query in a search effort. Also arranged are interactive graphic icons or buttons 54 and 56. Button 54 serves as a search button, which may be labeled “Search” or other search symbols. A user may click on it or tap it, assuming surface 64 is touch sensitive, to start a search process or a conventional search process. For a conventional search interface or search window on a screen, the search function is the only search option provided. A user may tap the search button to conduct a search, whether a search target is about an object or relations among objects.

On surface 64 however, comparison button 56 is arranged, which may be labeled “Compare” or another symbol indicating the compare meaning. In some embodiments, comparison button 56 may be placed proximate to search button 54, such as next to it, side by side, or one on top of the other. When the two buttons are next to each other, it is easy for a user to see them simultaneously and select one conveniently. Comparison button 56 may be arranged beneath button 54 as shown in the figure, on the top of button 54, or on the right hand side of it. In the latter arrangement, input window 52, buttons 54 and 56 form one line, which may be preferred in some applications. Moreover, button 56 may be arranged in an invisible state in a search interface or search window, and only become visible beside button 54 after query input window 52 receives some input. That is, comparison button 56 may be arranged in an invisible state at the beginning of a search process. Once a user starts keying in a word in window 52 or window 52 receives any input at least partially, button 56 may be switched from the invisible state to a visible state. An invisible comparison button means one fewer icon and may be helpful for arranging a neat screen view.

As shown in FIG. 8-A, a query “Pizza Time” is entered in window 52. After button 54 is tapped, a conventional search around “Pizza Time” is launched. On the other hand, when button 56 is tapped, a search for comparison results is initiated. To get comparison results, the searching system may first determine that the object is “Pizza Time” and then find out whether there is an entity at a database which represents the object “Pizza Time”. In this case, it is relatively simple to figure out a matching object from the query, as it is the query itself. If a query matches more than one object, the searching system may select one based on prearranged rules and begin a search process via the selected object. Alternatively, when a query matches multiple objects, a searching system may proceed along another route which is described below.

Return to FIG. 8-A. The screen view may remain the same after a query is keyed in, and may change after button 54 or 56 is tapped. In some other embodiments, when comparison results are available for an object, certain comparators may show up automatically right after a query is entered, which is illustrated graphically in FIG. 8-B. For example, after a user enters “Pizza Time” in window 52, a temporary comparison window 66 may show up below window 52. Comparators such as “My Pizza” and “Pizza Ace” may be presented in the temporary window 66. The two comparators may be selected from a group of comparators at comparison attributes. Window 66 may help a user in a search process, as it provides certain comparison information in advance. But appearance of a temporary comparison window doesn't mean comparison results will be retrieved and displayed. A user may still need to tap button 56 to get comparison results. In the meantime, a user may also tap button 54 for a conventional search.

In addition, after a user keys in a word or part of a word in window 52, temporary window 66 may show up and display a list of suggested queries. The suggested queries may be made based on a user's search history and possible queries containing the incomplete input in window 52. If a suggested query matches an object on record, selected comparators may appear along with suggested queries in window 66. When comparators and suggested queries are shown in window 66 together, a symbol like “Compare” may be arranged beside the comparators to distinguish them from the queries. After viewing the content items in window 66, a user may either tap a suggested query for a conventional search, or tap comparison button 56 for comparison results. Thus, window 66 may be arranged to assist two options or two kinds of searches.

After button 56 is tapped, its color and brightness may change to show the user selection and comparison results may be retrieved and presented as in FIG. 8-C. Upon receiving a query and comparison request, the searching system may find an object which matches a key item of the query. For the query “Pizza Time”, assume that there exists a matching object with the same name. Then, the object's entity and attributes are located at a database by the searching system. From the comparison attributes, comparators, comparison factors, and comparison values may be retrieved. Optionally, due to the screen size limit, not all comparators may be presented at a time. As shown in FIG. 8-C, two comparators “My Pizza” and “Pizza Ace” may be selected and presented in a comparison window 58. The two pizza competitors may be chosen based on their business nature and the close distance to “Pizza Time”. For the object and two comparators, a comparing act may be performed through comparison factors. As there may be many comparison factors, the searching system may select some for a user via certain algorithms according to prearrangements. For example, comparison factors “Rating”, “Review Qty”, and “Pricing” may be chosen and presented in window 58 as a default setting. In window 58, there may be three interactive icons that represent the comparison factors and bear their names respectively. When an icon is tapped, color of the icon may become brighter and corresponding comparison values may appear.

After window 58 appears, values of “Rating” may be shown as the first comparison results. The term “Rating” may be used to reflect how users feel about a business or product. For instance, on some reviews sites or in feedback emails, a user may be asked to rate a service or product, like using the number of stars. Summarization of the ratings, which may be done by an averaging method, may generate an average value. The average value may be used as a comparison value as well as a concise summary. In FIG. 8-C, the three businesses have 4.5, 4.7, and 3.9 stars respectively. Thus, it becomes easy and quick to compare the pizza places in terms of rating.

Next, the user may be interested in the “Review Qty” factor and may tap its icon to see the quantity of reviews each business receives in a given period of time. The comparison results are shown graphically in window 58 of FIG. 8-D. Quantity of reviews, which may be written and posted by users, may shed light on the popularity of a business or a product. More reviews may mean more customers and more popular. Thus comparison factor of review number may be a useful indicator when a user is making a decision on where to have a meal. The last comparison factor chosen by the searching system is of “Pricing”. The user may tap on its icon and get a screen view as shown in FIG. 8-E. Unlike the other two comparison factors, a value of “Pricing” factor may be a range, instead of a single number, although the average price may be used as the comparison value too. A price range may show the lowest price and the highest price. Although a list of average prices is easy for comparison, a price range may still be favored by some users and especially by restaurant owners, as it provides more information.

In descriptions above, comparison values are displayed separately for each comparison factor. Alternatively, comparison values of multiple comparison factors may be presented simultaneously in window 58 (not shown).

Therefore, it is seen that comparison results may be easy to get via a comparison button and furthermore, an object may be compared with comparators quickly and conveniently by comparison values. As a concise summary for an object or comparator may be used as a comparison value, a comparing act may be performed by comparing concise summaries. Hence, concise summaries may be specifically arranged so that they are easy and quick to view and comprehend. For instance, concise summaries may be arranged to have the same presentation format, similar or even the same wording, and/or have only a few elements only. Summary elements may include a numerical number, a word, letter, a character, a sign, or a symbol. Comparison values as shown in FIGS. 8-C to 8-E are examples of concise summaries, which have the same format, similar wording, and a few elements only.

In some embodiments, as a default configuration, only a few comparators may be selected for presentation by a searching system, like the two pizza places in descriptions above. Since some users may want to compare an object with more comparators or some comparators chosen under different rules, more choices may be arranged in a comparison window. For example in FIG. 8-F, two interactive buttons, button 60 “More” and button 62 “Other Comparisons” may added. When button 60 is tapped, more comparators may be presented so that comparisons may be held among more pizza businesses or in a wider range. For instance, certain pizza places located farther away may be included, when the comparison attributes have information about these comparators. Button 62 may represent another option that involves comparators of different kinds. For example, after button 62 is tapped, another icon may show up with a label such as “Restaurants with similar price” and additional comparators may be presented. The additional comparators may include eateries other than a pizza restaurant, e.g., a burger shop or a pancake restaurant that have a similar price range. Comparison attributes containing information of the additional comparators may be arranged in advance. When comparators are changed, comparison factors may remain the same.

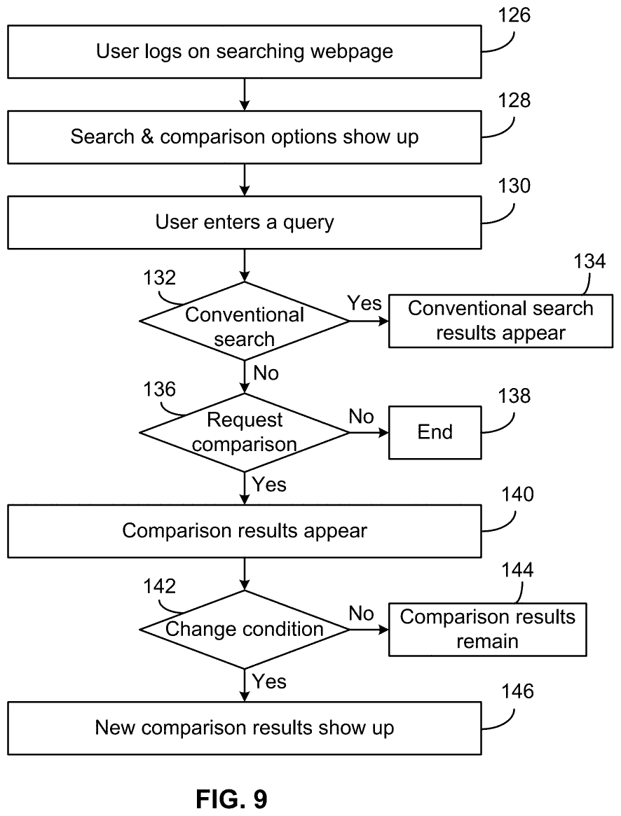

FIG. 9 shows an exemplary flow diagram that illustrates presentation of comparison results. A user logs on a search web page at an electronic device at step 126. Two options are provided on the web page for the user at step 128. The options may be represented by two interactive buttons. One option yields conventional search results, while the other option leads to comparison results. Next the user enters a query in a query input window at step 130. The user has two choices at step 132. For a conventional search, the user may activate a search button, and conventional search results may be displayed at the device at step 134. If the user doesn't want to do a conventional search, the user may tap a comparison button at step 136, and then comparison results may be obtained and presented at step 140. If the comparison button is not activated at step 140, the search process may end at step 138. At step 142 following step 140, the user needs to make another decision, i.e., whether to change the comparison condition. If the user doesn't change it, comparison results presented at the device remain the same at step 144. If the user activates a change button to change the comparison condition, such as increasing the number of comparators, showing more comparison factors, or adding additional comparators, new comparison results may be retrieved and presented at step 146.

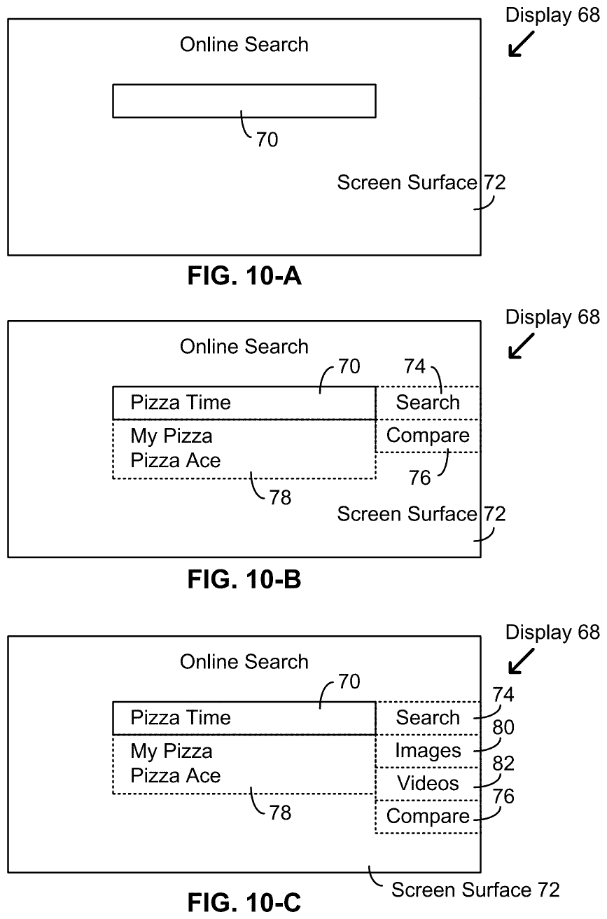

FIGS. 10-A to 10-C illustrate exemplary diagrams of presenting comparison results at a device according to the present invention. As shown in FIG. 10-A, a search interface or search window is arranged on a screen surface 72 of a display 68. The interface includes a query input window 70. The query input window may also be referred to as a query input space. A search button and a comparison button are not displayed initially, which may make the interface clean and neat. After a user enters a query in window 70, a search button 74 and a compare button 76 may show up together, e.g., on the right-hand side of window 70, as illustrated in FIG. 10-B. In some embodiments, buttons 74 and 76 may become visible after a query is entered at least partially in window 70, such as after a letter, a sign, or a number is entered. After a query, e.g., “Pizza Time”, is received at the device, corresponding comparators may be displayed or become visible in a comparison window 78, as depicted in FIG. 10-B. In some other embodiments, some items, which are not comparators but related to “Pizza Time” in certain ways, may also be displayed as suggested queries for a search in window 78.

After the query “Pizza Time” is entered and buttons 74 and 76 are presented, the user may tap on button 74 for conventional search results, or tap on button 76 for comparison results. The query may be transmitted to a search system or service facility by the device. Conventional search results and/or comparison results may be retrieved at the search system or service facility and sent to the device for presentation.

Alternatively, after a query is entered at least partially in window 70, buttons 80 and 82 may be presented (e.g., becoming visible) along with buttons 74 and 76 in the interface on surface 72, as shown in FIG. 10-C. Button 80 may be arranged for requesting an image search, and button 82 may be arranged for requesting a video search. As images and videos are popular search items, the needs for image search and video search grow steadily. As such, convenient options for image search and video search are desirable for a search interface, especially among young people. The image search and video search are different from a conventional search in that a search is focused on images or videos related to a search query. While conventional search results include information of all type of formats (e.g., textual content, images, audio, video, etc.), image search results may mainly include information related to images such as images or links to image files, and video search results may mainly include information related to videos such as videos or links to video files.

When buttons 80 and 82 are arranged, in some embodiments, the starting page may be similar to the interface shown in FIG. 10-A, i.e., clean and neat without showing any search buttons. After a query is entered at least partially, buttons 74, 76, 80, and 82 may appear together. A user may activate one among the four search buttons to start a conventional search, a comparison search, an image search, or a video search. The search process may be similar to those illustrated above. For example, after a search button is activated, the device may detect the user action, send a search request and a query received at the device to a service facility, and wait for a response from the service facility. Based on the query, the service facility may retrieve conventional search results, comparison results, image search results, or video search results accordingly. The retrieved information may be sent to the device, which may present the information at the device. Hence, buttons 74, 76, 80, and 82 may be used to provide four search options simultaneous. A user may select one option to do a regular search, comparison search, image search, or video search quickly and conveniently.

In some other embodiments when the comparison function is not arranged, a search button (e.g., button 74) may be displayed in a starting search interface. After a query is entered at least partially in a query input window, an image search button and a video search button may be presented (e.g., becoming visible) and disposed proximate to the search button. As such, options for three types of searches may be provided in the interface. A user may activate one of the three buttons to request a conventional search, an image search, or a video search.

In some other embodiments when the comparison function is not arranged, a starting search interface may be configured similar to that of FIG. 10-A, e.g., a query input window is provided without displaying any search buttons. After a query is entered at least partially in the query input window, a conventional search button, an image search button, and a video search button may be presented (e.g., becoming visible). The three buttons may be disposed proximate to each other such as one over another along a vertical direction. As such, options for three types of searches may be provided in the interface at the same time. A user may activate one of the three buttons to request a conventional search, an image search, or a video search.

### CONCLUSION, RAMIFICATIONS, AND SCOPE

Thus it can be seen that apparatus and methods are introduced to improve search methods and databases.

The described embodiments have the following features and advantages:
(1). Search and comparison options are provided in a search window;
(2). The comparison option provides comparison results, while the search option provides conventional search results;
(3). Comparison results are presented using concise summaries;
(4). Database is improved by addition of comparison attributes;
(5). Comparison attributes contain comparison data; and
(6). Comparison attributes enable retrieval of comparison information directly.

Although the description above contains many specificities, these should not be construed as limiting the scope of the invention but as merely providing illustrations of some of the presently preferred embodiments. Numerous modifications will be obvious to those skilled in the art.

### Ramifications:

The interface on screen surface 64 of FIGS. 8-C to 8-F may show more content items than what is depicted. As search results and comparison results are complementary, they may be obtained and presented together, when a user requests a comparison search for comparison results. For example, conventional search results may be retrieved and presented in an area below window 58. When a user looks at comparison results about an object and becomes interested in the object, the user may tap a link displayed below window 58 to learn more about it conveniently.

A comparison button like a “Compare” button may be placed close to a search button no matter what interface the search button is arranged in. That is, the comparison functionality may be arranged to take effect in any interface where the search functionality exists. The interface may be a web page of a search website, an online store website, a business reviews website, a government website, etc.

Rules may be made for selecting comparators for an object. To qualify as a comparator, it must have the same or similar features or characteristics, when compared to the object. Some features or characteristics are what a comparison is based on and may be used as comparison factors. For example, if an object is a product, other products which have similar specifications but different brands may be taken as comparators. They may be compared by price, common parameters, or other comparison factors. Besides, other products of the same brand and similar functions may be used as comparators too. If an object is a book, other books which have the same or similar topic may be enlisted as comparators. The books may be compared by review rating, price, number sold, etc. In addition, other books written by the same author but with different topics may also serve as comparators. If an object is a restaurant, nearby restaurants of the same cuisine may be chosen as comparators. Moreover, nearby restaurants which serve different cuisine with a similar price range may serve as comparators too. If an object is a country, neighboring counties or countries which the media often cite when reporting the country may be selected as comparators.

Rules may also be made for selecting comparison factors. An object and its comparators are compared by comparison values under a group of comparison factors. As comparisons may be made via various aspects, there may be many potential comparison factors. Thus, rules should be made to define which comparison factors are selected. The rules may be related to users' needs and general trend. In addition, similar objects may have the same requirements for comparison factors. For a product, possible comparison factors may include price, review rating, life time, key specifications, etc. For a book, possible comparison factors may include price, review rating, quantity sold, etc. For a country, likable comparison factors may be population, area, gross domestic product (GDP), and so on.

Besides clicking and tapping using a computer mouse or fingertip, vocal instructions may also be used to do a search and get search or comparison results, when a client system has a voice recognition mechanism or is equipped with a voice recognition component. Vocal input may be especially favored when VR and AR devices are involved, since input by tapping on a screen surface becomes unavailable. For instance, after a search interface such as that of FIG. 8-A shows up on a virtual screen, a user may speak to a VR device, “Key in “Pizza Time” please” and then say “Compare” to start a compare process and get comparison results, e.g., comparison values under the comparison factor “Rating”. Next the user may say “Pricing” to change the comparison factor from “Rating” to “Pricing”. In addition, when a VR device has a gesture sensor, a user may use virtual clicking or virtual tapping acts to enter input. Then the user may ask for comparison results via gesture instructions.

Sometimes when the purpose of search is to get certain images or videos, it may be arranged such that search results are presented using images or links to web pages containing videos. For such a searching process, a comparison button may still be arranged next to a search button to provide a comparison option. It may be arranged such that besides textual content, an image or video alone may represent a comparison value or concise summary as well. In other words, a comparison value or concise summary may contain an image or a video only. For instance in a comparison window like that of FIG. 8-C, images or links to video websites for an object and its comparators may be displayed under a comparison factor. A video clip may also be embedded in an icon in a search window. The icon may stand for a comparison value. A user may tap the icon to view the video directly. Thus aside from comparing things by textual content, a comparison may be made by comparing images or videos too.

In some embodiments as described above, comparison results may be presented using a few numbers, a few signs, and/or a few words in a search window. But a user may want to see comparison results in images or videos in some occasions, even though a search is not conducted among images or videos. For instance, when a user is looking at comparison results made up of numbers and words, the user may want to compare the parties by images or videos. Then, additional comparison factors may be created at comparison attributes and named, for example, “Image” and “Video”. Accordingly, additional comparison factor icons, such as “Image” and “Video”, may be arranged along with other comparison factor icons in a comparison window. As such, some comparison values may be arranged to be a selected image or video clip that represents an object. For example, a representative image of a restaurant may be a picture of its popular dish or an award-winning interior design. For a movie, a representative video may be its trailer. When “Image” or “Video” factor is selected, images or videos chosen for an object and its comparators may be displayed together, which make it convenient for a user to compare one against another. Comparison of images or videos may be useful when a user tries to choose a movie, a TV show, a concert, a restaurant, a park, and so on.

When a query or object has multiple meanings, multiple temporary comparison windows like window 66 of FIG. 8-B may appear in a search interface. The multiple windows may represent the meanings, respectively. A user may tap an item in one window and then tap a comparison button to start a search. Next comparison results based on the select meaning may be retrieved and displayed.

In FIG. 8-F, an “Edit” button may be configured in the interface (not shown). The button may provide options to adjust rules for selecting comparators and comparison factors. For example, a user may tap “Edit” button to open an edit window and then enter an editing mode. In the editing mode, the user may change parameters and conditions which define a comparator selecting process. For example, a user may change the maximum distance allowed between an object and a comparator. The user may also add for an object requirement for delivery service or requirement for online ordering service. The user may also specify which comparison factors may show up first.

As in some cases a user may want to see detailed information after viewing concise summaries, an interactive button, which may have a label such as “Detail”, may be configured on surface 64 of FIG. 8-F (not shown). The button may be designed to provide a list of links of review reports or articles. So a user may start a search for comparison info on an object, take a look at concise summaries provided as comparison results, and then tap the “Detail” button to retrieve links to review reports which are related to the concise summaries. To accommodate such a function, more information may be collected and added to comparison attributes of entities or objects. Thus, comparison attributes may have not only comparison values which are in a concise form, but also links to sources from which comparison values are obtained or derived. Through the links, a user may access articles, news, posts, or reports on an object. Information from these links may differ from conventional search results, because the information may be related to a comparator. For example, a comparison-related article may focus on comparators of an object, not the object.

Lastly, an interactive arrow button may be configured on the right hand side of “Pricing” button of FIGS. 8-C to 8-F (not shown). The arrow button may be placed next to “Pricing” button and have an arrow symbol on it that points to the right-hand direction. If the arrow button is tapped, an icon of a new comparison factor may appear. A user may tap the new icon to see comparison values under the new comparison factor for the three pizza places. The arrow button brings options for more comparison factors and consequently more comparison results. Again, it is assumed that comparison attributes contain more comparison factors than those shown in a comparison window. The arrow icon enables a user to select every comparison factor available at comparison attributes, which provides flexibility for comparison window design and convenience for users.

Therefore the scope of the invention should be determined by the appended claims and their legal equivalents, rather than by the examples given.

1. A searching system arranged for working with an electronic device having stored executable instructions, comprising:
a communication component for communicating between the system and the electronic device via a communication network and sending information for the electronic device to display a plurality of content items on a screen, wherein the plurality of content items include an input space for a user to enter a query for a search process, an interactive search element as a search option, and an interactive comparison element as a comparison option, and the interactive search element and the interactive comparison element are arranged proximate to each other on the screen;
a receiving component for receiving the query after the user enters the query, wherein the query is a search request when the user activates the interactive search element, and the query is a comparison request when the user activates the interactive comparison element;
a comparing component for obtaining an object based on the query and obtaining one or more comparators which are comparable to the object when the query is the comparison request; and
a presentation component for obtaining search results based on the query when the query is the search request or obtaining comparison results based on the object and the one or more comparators when the query is the comparison request, wherein the comparison results comprise a plurality of concise summaries based on the object, the one or more comparators, and a comparison factor, and the communication component is configured to send the user the search results when the query is the search request or send the user the comparison results when the query is the comparison request.

2. The system according to claim 1 wherein the comparison results comprise a plurality of other concise summaries based on the object, the one or more comparators, and another comparison factor.

3. The system according to claim 1, further including a database, the database comprising the plurality of concise summaries and a plurality of other concise summaries based on the object, the one or more comparators, and another comparison factor.

4. The system according to claim 1 wherein another concise summary based on another comparator is sent to the user in response to receiving another request from the user.

5. The system according to claim 1 wherein both the search results and the comparison results are sent to the user after receiving the query.

6. The system according to claim 1 wherein the plurality of concise summaries each contain no more than a few items besides expression of summary identity, the items including a number, a word, a letter, a character, a sign, a symbol, an image, or a video clip.

7. The system according to claim 1 wherein the plurality of concise summaries have a same presentation format.

8. A computer implemented method performed for presenting search results and comparison results at an electronic device, the electronic device having an interface and stored executable instructions, comprising:
presenting a query input space in the interface for a user to enter a query for a search process;
presenting simultaneously in the interface an interactive search element and an interactive comparison element, wherein the search element provides a search option for obtaining the search results which are based on the query, the comparison element provides a comparison option for obtaining the comparison results which are based on an object obtained from the query and one or more comparators comparable to the object, and the search element and the comparison element are proximate to each other in the interface;
sending the query to a service facility after the user enters the query and activates the search element or activates the comparison element;
receiving from the service facility the search results after the search element is activated or receiving from the service facility the comparison results after the comparison element is activated; and
presenting in the interface the search results or comparison results after the receiving step, the comparison results comprising a plurality of concise summaries based on the object, the one or more comparators, and a comparison factor.

9. The method according to claim 8 wherein the one or more comparators become visible in the interface after at least part of the query is entered in the query input space.

10. The method according to claim 8 wherein the comparison element becomes visible in the interface after at least part of the query is entered in the query input space.

11. The method according to claim 8 wherein the search element and the comparison element become visible in the interface after at least part of the query is entered in the query input space.

12. The method according to claim 8 wherein the plurality of concise summaries have a same presentation format.

13. The method according to claim 8 wherein the plurality of concise summaries each contain no more than a few items besides expression of summary identity, the items including a number, a word, a letter, a character, a sign, a symbol, an image, or a video clip.

11. The method according to claim 8 wherein an image search element for an image search and/or a video search element for a video search becomes visible in the interface after at least part of the query is entered in the query input space.

15. A computer implemented method performed for presenting comparison results at an electronic device, the electronic device having an interface and stored executable instructions, comprising:
presenting a query input space in the interface;
making an interactive comparison element visible for a comparison request after a query is entered at least partially in the query input space by a user;
transmitting the query to a service facility after the comparison element is activated by the user;
obtaining the comparison results from the service facility, the comparison results comprising comparison information about an object obtained from the query and one or more comparators which are comparable to the object; and
presenting in the interface the comparison results, the comparison results further comprising a plurality of concise summaries based on the object, the one or more comparators, and one or more comparison factors.

16. The method according to claim 15, further including presenting simultaneously in the interface search results based on the query and the comparison results.

17. The method according to claim 15, further including making an interactive search element for a search request and the interactive comparison element visible simultaneously after the query is entered at least partially in the query input space.

18. The method according to claim 15 wherein the plurality of concise summaries each contain no more than a few items besides expression of summary identity, the items including a number, a word, a letter, a character, a sign, a symbol, an image, or a video clip.

19. The method according to claim 15 wherein the query is received through a voice recognition mechanism.

20. The method according to claim 15 wherein one of the plurality of concise summaries contains an image or a video clip only.
